(19) United States
(12) Patent Application Publication
(10) Pub. No.: US 2007/0182342 A1
(43) Pub. Date: Aug. 9, 2007

(54) LCD BACKLIGHT DRIVER

(75) Inventors: Mark David Hagen, Rochester, MN (US); Eric Gregory Oettinger, Rochester, MN (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/461,808

(22) Filed: Aug. 2, 2006

Related U.S. Application Data
(60) Provisional application No. 60/704,612, filed on Aug. 2, 2005.

(51) Int. Cl. H05B 41/16

(52) U.S. Cl. 315/274

(57) ABSTRACT

Three example inverter designs are described that can be tailored to drive from one to dozens of lamps of a backlight for a liquid crystal display. For each design the lamps are driven by a 40 kHz to 60 kHz sine wave. The lamp voltage is ˜1200V to “strike” the lamps and ˜600V to produce the optimal 5 mA in each lamp. The designs are: a Royer linear oscillator driven by a buck converter stage, a push-pull inverter that drives the high voltage transformer directly, and a class-D amplifier that produces the drive sine wave using a pulse width modulation technique.

### CROSS-REFERENCE TO RELATED APPLICATIONS

This application claims priority of U.S. Provisional Application Ser. No. 60/704,612, filed Aug. 2, 2005.

### TECHNICAL FIELD

The invention relates to Liquid Crystal Displays (LCDs) and, more particularly, to improved drivers for digitally controlling a CCFL/EEFL backlight inverter for an LCD.

### BACKGROUND

LCDs (Liquid Crystal Displays) require a backlight which consists of several fluorescent tubes. The lifetime of these tubes is one of the major factors influencing reliability of the display. While all the factors that influence lifetime are not completely understood, one of the factors is the waveform of the voltage driving the bulbs. The bulbs are typically driven with a sinusoidal waveform; however, sudden starts are known to be a lifetime influencing event. With the uncertainty of factors affecting life, more control of the waveform is desirable.

### SUMMARY OF THE INVENTION

This disclosure provides methods and apparatus for excellent control over the driving waveform. Additionally, the disclosed methods and apparatus can be used to stagger the phase of the multiple bulbs in the system, which may be advantageous for the power supply or might be used to improve any visual artifacts created if the frequency or phase differences between bulbs have some noticeable interaction.

In accordance with an aspect of the invention, the duty cycle of a PWM (Pulse Width Modulator) signal is modified on a cycle-by-cycle basis to produce a PWM sine wave (or any other desired waveform such as, for example, a chirp function which may be useful). To produce a sine wave, the PWM period is kept constant and the duty cycle gradually increases and decreases as the sine. One straightforward example implementation serves to store the sine wave values in a table, and at the PWM rate, modifies the PWM period according to the table entry.

For the example, the output waveform content will be significantly lower that the PWM frequency. In the example, a 720 kHz PWM frequency is used to produce a 60 kHz sine wave. The PWM output is fed into a gate driver which is used in conjunction with a filter network to strip off the high frequency PWM chopping and modulate the primary side of the transformer used to drive the CCFL tubes.

Many prior backlight controllers are analog. This is a digital solution. This solution can provide much tighter control of the driving waveform than other known solutions. Further, it can be used to produce multiple output channels. With knowledge of the other channels, it is possible to control the phases of one channel to another.

There are many advantages provided by the example embodiments. Finer control of the driving waveform may be used to extend the life of the fluorescent tubes (one of the key issues in the LCD backlight market today). Additionally, the phase control between channels may be used to reduce some of the requirements on the power supply.

The DSP (Digital Signal Processor) which produces the sine wave can be used to compensate for some non-linearities in the system—modifying the sine wave with far more control than is possible in known systems. In the case of the sine table implementation, the waveform can be adjusted in advance to perform the linearizing function with no run-time computation penalty.

Cold Cathode Fluorescent Lamps (CCFL) and External Electrode Fluorescent Lamps (EEFL) are used to produce the backlight for Liquid Crystal Displays (LCD) of all sizes. Large format LCDs can contain dozens of lamps and are routinely used in applications that run nearly continuously. For these applications the reliability of the system can be limited by the reliability of the backlight. Applying digital control to the design of the backlight inverter can improve reliability by more tightly controlling the frequency and phase of each lamp and by applying sophisticated soft start and lamp ignition routines.

The following detailed description describes three example inverter designs that can be tailored to drive from one to dozens of lamps. For each design the lamps are driven by a 40 kHz to 60 kHz sine wave. The lamp voltage is ˜1200V to “strike” the lamps and ˜600V to produce the optimal 5 mA in each lamp. The designs are: 1) a Royer linear oscillator driven by a buck converter stage, 2) a push-pull inverter that drives the high voltage transformer directly and 3) a class-D amplifier that produces the drive sine wave using a pulse width modulation technique. The cost, efficiency and reliability characteristics of each inverter are addressed.

By applying a DSP such as the UCD9501 to the design of a backlight inverter, arbitrarily complicated soft start voltage and current profiles can be produced using lookup table techniques. Also, by sensing the output voltage and current with a ADC, the detection of a lamp that fails to ignite and the recovery routines needed to strike the lamp can be developed in software. For instance the CCFL strike voltage typically increases with age, so the processor can perform retries with ever increasing voltage without the need to apply that large voltage on every start over the life of the lamps.

### BRIEF DESCRIPTION OF THE DRAWINGS

Example implementations of the invention are described below, with reference to accompanying drawings, wherein:

FIG. 1 shows an example CCFL Construction.

FIG. 2 shows an analog Royer oscillator inverter.

FIG. 3 shows Royer inverter waveforms.

FIG. 4 shows an example digitally controlled Royer inverter implementation.

FIG. 5 shows an example push-pull inverter implementation.

FIG. 6 shows a graph of push-pull lamp current vs duty cycle.

FIG. 7 shows separate measurement of lamp currents.

FIG. 8 shows an example Class-D inverter implementation.

FIG. 9 shows a Class-D output filter equivalent circuit.

FIG. 10 shows PWM scope traces.

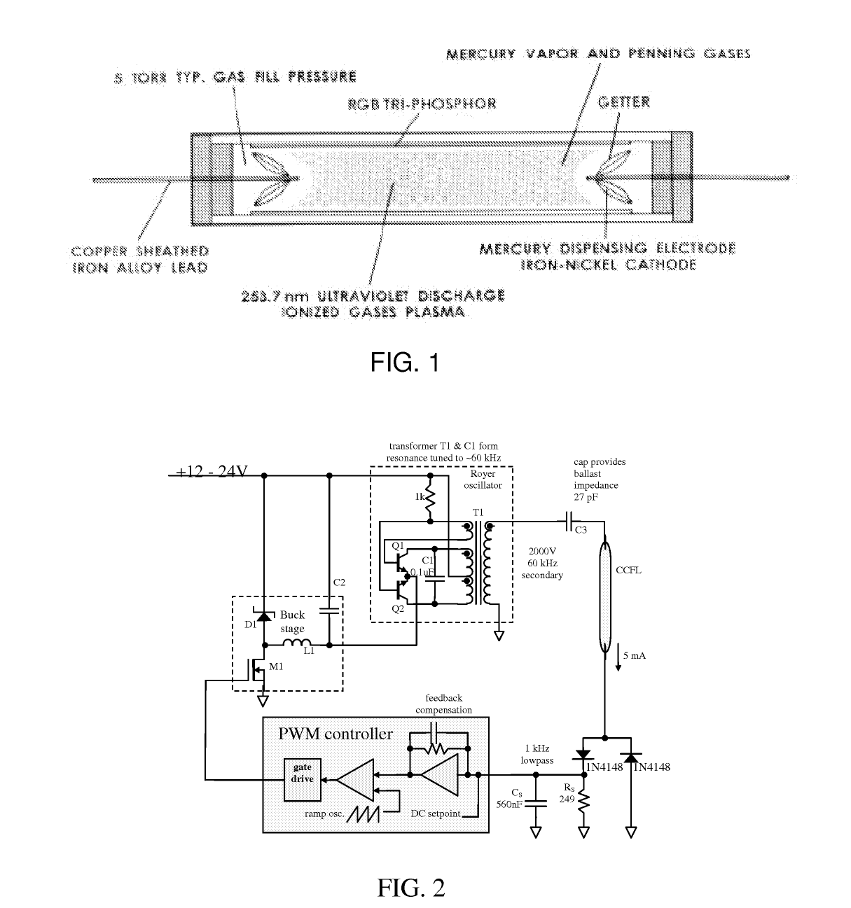

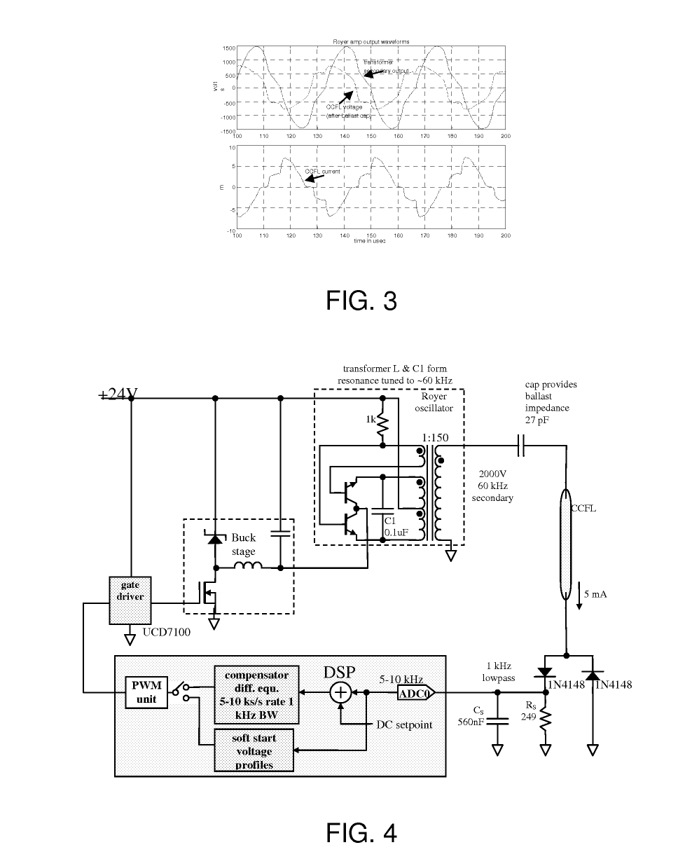

### DETAILED DESCRIPTION OF EMBODIMENTS

Cold Cathode Fluorescent Lamps (CCFL) and External Electrode Fluorescent Lamps (EEFL) are similar to the neon gas-discharge lamp invented in 1910 by Georges Claude in Paris, France. Like all fluorescent lamps, they work by applying a sufficiently large voltage across the device to ionize the contained gas which stimulates the phosphor coating inside the glass lamp envelope.

CCFLs are so named because of the type of electrode in the lamp ends. Unlike architectural fluorescent lamps, cold cathode electrodes do not rely on additional means of thermonic emission besides that created by the electrical discharge The typical CCFL is a hollow glass cylinder coated inside with a phosphor material composed of rare earth elements and sealed with a gettered electrode at both ends. The lamps normally contain 2-10 milligrams of mercury along with a mixture of gases, such as argon and neon. Ultraviolet energy at 253.7 nm is produced by ionization of the mercury and penning gas mixture by the application of high voltage through the tube. See, John H Kahl, “CCFL's, A History And Overview,” JKL Components Corporation, App. Note # AI-002, 1997.

EEFLs operate similarly to CCFLs, except that the electrode is external to the glass tube and the excitation voltage is applied to the gas capacitively.

To drive a CCFL, a large sinusoidal voltage is applied to the electrodes to initiate the ionization of the gas. This is called the strike voltage and for a typical 3.0 mm by 380 mm lamp this can be as high as 2000V. Once the lamp begins to conduct it's impedance drops and the applied voltage must be reduced in order to arrive at the desired lamp current. Most lamps are designed to operate at 5 mA. This negative impedance as the lamp is being ignited is one of the confounding aspects of CCFL drive circuits. Jim Williams wrote an excellent review in 1995. See, Jim Williams, “A Fourth Generation of LCD Backlight Technology”, Linear Technology Application Note #65, Nov. 1995.

Operating a CCFL over time results in degradation of light output. Lamp phosphor degradation produces the corresponding reduction in output. Typical CCFL life ratings in lamp manufactures' catalogs are stated as 20,000 hours to 50% of the lamps initial output at a drive current of 5 mArms.

Both fast voltage rise times and DC content in the drive voltage have been shown to degrade the phosphor by encouraging mercury vapor migration. Therefore, an inverter that provides a low crest factor sinusoidal waveform with minimal D.C. content provides the best lamp life.

Strategies for Improving Lamp Life

The frequency at which a CCFL or EEFL is driven is a trade off between component cost (higher frequencies allow smaller components) and efficiency (high frequencies mean more switching loss and more capacitive losses in the wiring between the high voltage transformer and the lamp). Typically 40-60 kHz is chosen as the drive frequency. To minimize fast edges on the drive current, a sinusoidal voltage is generated to drive the lamp. This alone may not be enough to minimize the slew rate of the lamp current. The nonlinear V-I characteristics of lamp can introduce substantial harmonics in the lamp current. By “pre-distorting” the sinusoidal drive waveform the nonlinearity can be compensated for.

The other event that appears to effect lamp life occurs during turn-on. Utilizing soft start techniques to manage the current transient as the lamp strikes can maximize lamp life.

The Royer Oscillator Inverter

A very common inverter circuit topology for driving a single CCFL is the Royer oscillator inverter. In this application Q1 and Q2 are alternately driven by a third winding on the transformer forming a linear oscillator. The voltage across the oscillator is provided by a switch-mode converter stage. This is usually a buck converter, flipped relative to the power rail so that the MOSFET gate can be driven from ground.

The drive frequency is defined by the LC tank consisting of the transformer primary and capacitor C1. This oscillation frequency will vary with component drift, tolerance variation and load current. A typical design will have a nominal frequency of 55 kHz ±5 kHz. The capacitor C3 provides a ballast impedance for the lamp. That is, it limits the current during normal operation. During start-up the lamp is off and no current flows through the lamp. This means that there is no voltage drop across the capacitor and all the inverter voltage is across the lamp. When the lamp strikes, current begins to flow which causes a voltage drop across the capacitor. If the bandwidth of the PWM controller is fast enough, the ballast capacitor can sometimes be eliminated.

The lamp current control loop is formed by sensing lamp current in resistor R₅, comparing to a desired current reference and then using this error signal to construct a pulse width modulated (PWM) gate drive for the MOSFET switch. Dimming can be done either by adjusting the setpoint or by turning the whole system on and off at a 300 to 1000 Hz rate. This slow PWM rate is fast enough so that the lamp remains ionized between on times.

The Royer Oscillator Inverter with a Digital Controller

The analog controller in a Royer oscillator inverter can be replaced with a digital signal processor. Although this maybe considered overkill for normal operation, the DSP can provide value during start-up. By accurately measuring lamp current, the processor can generate a variety of soft start control profiles. For instance the processor can slew the PWM signal to a maximum duty cycle and wait there for the lamp to strike, if it fails to strike the controller can retry the start sequence, slewing to a higher maximum duty cycle with each retry until the lamp strikes. In this way the lamp will see a lower strike voltage over the life of the lamp than if the controller is programmed to generate a strike voltage sufficiently high to always ignite the lamp over its designed life. As a result the life of the lamp can be extended.

while( !ignite )
{
softStart(maxDrive(retryCount));
for( n= 0; n < NUM_LAMPS < n++; )
{
ignite = TRUE;
if( lampCurrent[n] < START_THRS )

ignite = FALSE

}
}

The Push-Pull Inverter

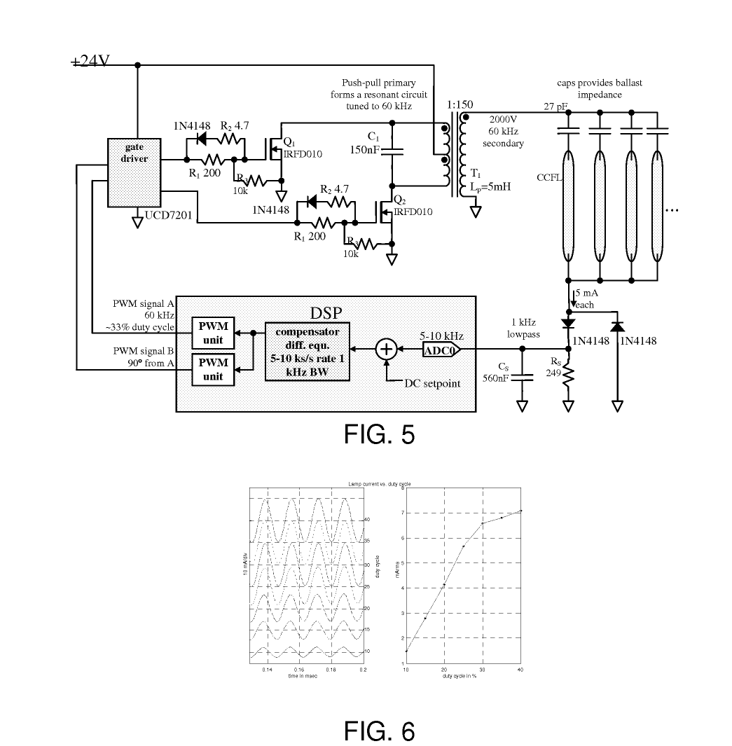

Since the Royer oscillator is a linear circuit, it is limited to low power applications where one or two lamps are to be driven. For applications with many lamps, alternative switch-mode techniques need to be used. One technique is the push-pull inverter shown in FIG. 5.

Q1 and Q2 alternately drive the center tapped transformer. When Q1 is turned on, current ramps in that half of the primary and 2× the supply voltage is applied across the capacitor C₁ through transformer action. When Q1 opens at the end of the PWM pulse the current circulates between C₁ and the transformer primary. The resulting sine wave is coupled to the secondary and provides the lamp drive voltage.

For the push-pull inverter, the frequency of the PWM control signal is the same as the drive frequency. Therefore the transformer inductance needs to be larger and more expensive than it might be with a technique using a PWM frequency that is higher than the drive frequency. On the other hand, the relatively low switching frequency means that the switching losses are minimized. The transfer function of PWM duty cycle to lamp current can be seen in FIG. 6 Error! Reference source not found.

A digital compensator, implemented as a second order difference equation in the processor, calculates duty cycle for each PWM output. The second order compensator is one of several of the digital power library function that are available for a UCD9501 DSP.

The same soft start algorithms that was discussed for the Royer oscillator design can be used in the push-pull inverter design.

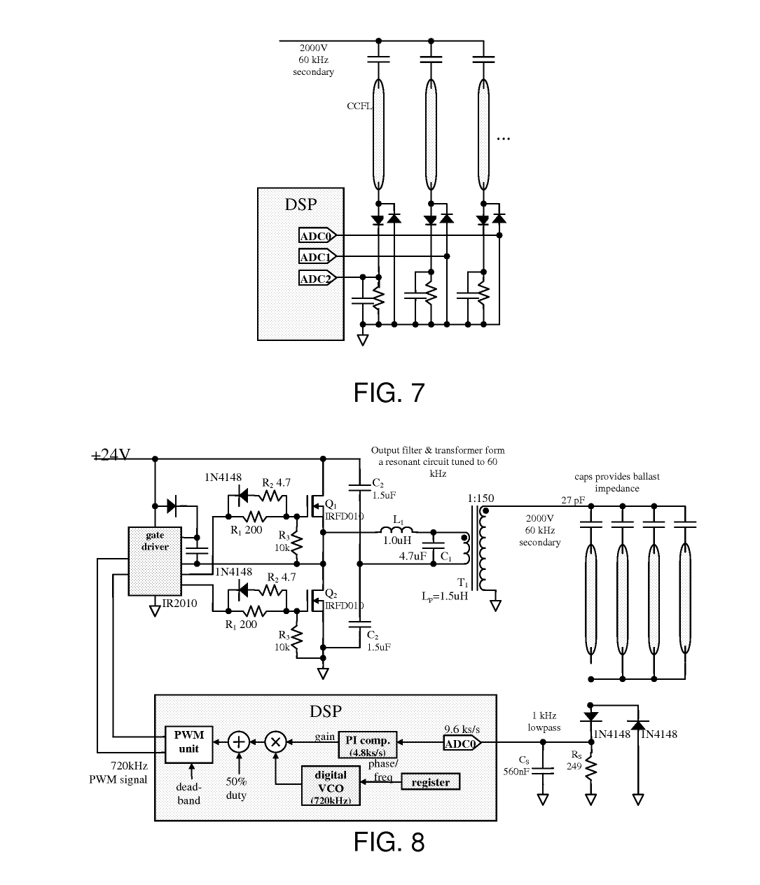

FIG. 7 shows an alternative where each lamp is separately measured using a DSP ADC channel for each lamp. The UDC9501 DSP has a 16 channel ADC and up to 16 PWM channels. This allows one DSP to control many lamps.

The Class-D Inverter

A third approach that can be used to drive a CCFL or EEFL is to generate the driving sine wave with a class-D amplifier. FIG. 8 shows a half-bridge implementation where Q₁ and Q₂ form a class-D amplifier output section. The amplifier output drives a high voltage transformer which is coupled to the parallel connected fluorescent lamps. An advantage of this approach is that the PWM switching frequency is much higher than the drive frequency. Therefore smaller sized components can be used. Secondly, the drive waveform is not limited to a pure sine wave. By using a table look-up technique to define the PWM duty cycle sequence, the inverter can compensate for the non-linear V/I characteristics of the lamp.

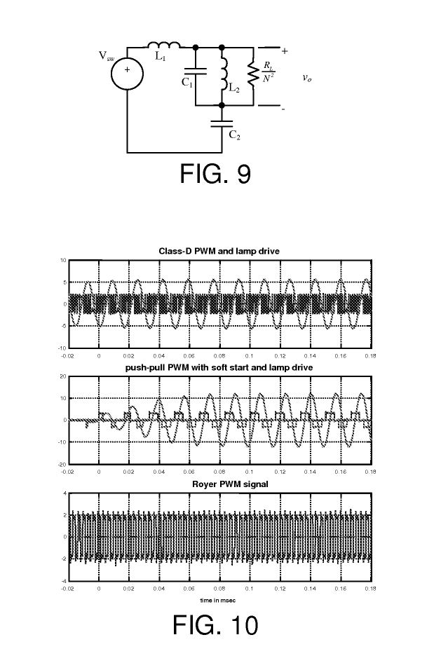

FIG. 9 shows the equivalent circuit for the output filter of the class-D amplifier. The frequency domain transfer function for this network is:

$${v}_{o} = \frac{1}{{RL}_{1} {C}_{1}} \frac{{s}^{2} {v}_{sw}}{\begin{matrix}{s}^{ 4} + \frac{1}{ {RC}_{ 1}} {s}^{ 3} + ( \frac{1}{ {L}_{ 1} {C}_{ 1}} + \frac{1}{ {L}_{ 1} {C}_{ 2}} + \frac{1}{ {L}_{ 2} {C}_{ 1}} ) {s}^{ 2} + \\ \frac{1}{ {RL}_{ 1} {C}_{ 1} {C}_{ 2}} s + \frac{1}{ {L}_{ 1} {L}_{ 2} {C}_{ 1} {C}_{ 2}}\end{matrix}}$$

Where

$$R = \frac{{R}_{Lamp}}{{N}_{turns}^{2}} .$$

This forms a fourth order band-pass filter. The inductance of the series inductor and transformer are selected based on the desired peak current. Then C₂, which is actually the parallel combination of two capacitors between the power rail and ground, defines the low frequency corner and C₁ defines the high frequency, low-pass corner of the filter network. In order to allow the system to compensate for the non-sine lamp current the output filter needs to pass both the fundamental drive frequency and its 3rd harmonic. So if a drive frequency of 40 kHz is chosen, then the band-pass frequencies of the output filter need to run from 40 kHz to 120 kHz.

The control effort for the class-D inverter is a little different from the first two implementations. For the Royer oscillator and Push-Pull inverter designs the lamp current is sensed and compared to the desired set point to generate an error signal. The error signal is phase compensated and fed directly to a pulse width modulator. For a class-D implementation, the PWM controller output is a sequence of PWM periods where the pulse width deviates from a 50% duty cycle on a pulse by pulse basis. In this case the pulse width variation follows a sine wave at the drive frequency. The lamp current error signal then is used to vary the amplitude (from a 50% duty cycle) of this PWM sequence.

To generate the sine wave sequence, a table lookup sine wave generator can be used. The table consists of N samples covering one cycle of a sine wave. A step state-variable ? is defined such that

$$η = \frac{{F}_{s}}{{F}_{drive}} {2}^{16}$$

(for a 16 bit processor). The sine wave is generated by accumulating the variable ? to produce phase T. T is then right shifted 16-log₂(N_{table}) and used as a pointer into the table to define the sine output.

#define SINE_TABLE_SCALE 16 - log2(N_TABLE)

| | | |
|---|---|---|
| theta += eta; | // allow theta to wrap as | //it reaches 2\hat{ }16 |

sine = sineTable[theta >> SINE_TABLE_SCALE];

| | |
|---|---|
| pwm = gain * sine; // apply gain based on | // Ilamp |
| feedback | |

FIG. 10 shows captured scope traces of the PWM controller output for the three inverter implementations.

Since the PWM command for the class-D amplifier/inverter is driven from a table we are not limited to a pure sine wave. Any arbitrary waveform can be encoded into the look-up table and sequenced through at the drive frequency. In this way non-linearities in the lamp V/I curve can be compensated for when constructing the table. The turn on threshold of the lamp generates substantial 3rd harmonic in the lamp current, by adding third harmonic content to the table this distortion can be attenuated.

Those skilled in the art to which the invention relates will appreciate that other embodiments exist and that various additions, deletions, substitutions and other modifications may be made to the described embodiments, all within the scope of the claimed invention.

What is claimed is:

1. The methods and apparatus for digitally controlling a backlight inverter for a liquid crystal display, as shown and described.
